(19) United States
(12) Patent Application Publication
(10) Pub. No.: US 2016/0245184 A1
(43) Pub. Date: Aug. 25, 2016

(54) GEARED TURBINE ENGINE

(71) Applicant: United Technologies Corporation, Hartford, CT (US)

(72) Inventors: Frederick M. Schwarz, Glastonbury, CT (US); William G. Sheridan, Southington, CT (US)

(21) Appl. No.: 14/626,534

(22) Filed: Feb. 19, 2015

(51) Int. Cl. F02C 7/36; F02C 3/04

(52) U.S. Cl. CPC F02C 7/36; F02C 3/04

(57) ABSTRACT

A turbine engine is provided that includes a fan rotor, a first compressor rotor, a second compressor rotor, a third compressor rotor, a first turbine rotor, a second turbine rotor, a third turbine rotor and a gear train. The fan rotor and the first compressor rotor are connected to the first turbine rotor through the gear train. The second compressor rotor is connected to the second turbine rotor. The third compressor rotor is connected to the third turbine rotor.

### BACKGROUND OF THE INVENTION

1. Technical Field

This disclosure relates generally to a geared turbine engine.

2. Background Information

Various types of turbine engines for propelling an aircraft are known in the art. One exemplary turbine engine type is a geared turbofan turbine engine. A typical geared turbofan turbine engine includes a gear train, a fan rotor and a core. Typically, the core consists essentially of a low speed spool and a high speed spool. The gear train connects the fan rotor to the low speed spool and enables the low speed spool to drive the fan rotor at a slower rotational velocity than that of the low speed spool. Another example of a geared turbofan turbine engine is disclosed in U.S. Pat. No. 8,869,504 to Schwarz et al., which is hereby incorporated herein by reference in its entirety. While such turbine engines have various advantages, there is still a need in the art for improvement.

### SUMMARY OF THE DISCLOSURE

According to an aspect of the disclosed invention, a turbine engine is provided that includes a fan rotor, a first compressor rotor, a second compressor rotor, a third compressor rotor, a first turbine rotor, a second turbine rotor, a third turbine rotor and a gear train. The fan rotor and the first compressor rotor are connected to the first turbine rotor through the gear train. The second compressor rotor is connected to the second turbine rotor. The third compressor rotor is connected to the third turbine rotor.

According to another aspect of the disclosed invention, another turbine engine is provided that includes a first rotating assembly, a second rotating assembly and a third rotating assembly. The first rotating assembly includes a fan rotor, a first compressor rotor, a first turbine rotor and a gear train. The second rotating assembly includes a second compressor rotor and a second turbine rotor. The third rotating assembly includes a third compressor rotor and a third turbine rotor.

According to still another aspect of the disclosed invention, a method for manufacturing is provided. This method includes steps of manufacturing a first turbine engine configured for a first thrust rating and manufacturing a second turbine engine configured for a second thrust rating which is different than the first thrust rating. The first turbine engine includes a rotating assembly and a first multi-spool core, where the rotating assembly includes a fan rotor, a compressor rotor, a turbine rotor and a gear train. The second turbine engine includes a second multi-spool core. An upstream-most set of compressor blades of the first multi-spool core defines a first area. An upstream-most set of compressor blades of the second multi-spool core defines a second area that is within plus/minus twenty percent of the first area. The first and the second turbine engines are manufactured by and/or for a common entity.

A first shaft may be included and connect the gear train to the first turbine rotor. A second shaft may be included and connect the second compressor rotor to the second turbine rotor. A third shaft may be included and connect the third compressor rotor to the third turbine rotor.

The second shaft may extend through the third shaft. The first shaft may extend through the second shaft.

The first compressor rotor may be connected to the gear train through the fan rotor.

The first compressor rotor may be connected to the gear train independent of the fan rotor.

The first compressor rotor may include a first set of compressor blades and a second set of compressor blades downstream of the first set of compressor blades.

The fan rotor may include one or more variable pitch fan blades.

The variable pitch fan blades may be configured to move between a first position and a second position. The fan rotor may be operable to provide forward thrust where the variable pitch fan blades are in the first position. The fan rotor may be operable to provide reverse thrust where the variable pitch fan blades are in the second position.

A nacelle may be included housing the fan rotor. The nacelle may include a translating sleeve configured to open a passageway through the nacelle where the variable pitch fan blades are in the second position. The translating sleeve may be configured to close the passageway where the variable pitch fan blades are in the first position.

A leading edge of a first of the variable pitch fan blades may move in a forward direction as that blade moves from the first position to the second position.

The gear train may connect the fan rotor and the first compressor rotor to the first turbine rotor.

The first compressor rotor may be connected to the gear train through the fan rotor.

The fan rotor and the first compressor rotor may be connected to the gear train in parallel.

The gear train may connect the fan rotor to a shaft. The shaft may connect the gear train and the first compressor rotor to the first turbine rotor.

The first compressor rotor may consist essentially of (only include) a rotor disk and a set of compressor blades arranged around and connected to the rotor disk.

The first compressor rotor may include a rotor disk, a first set of compressor blades and a second set of compressor blades. The first set of compressor blades may be arranged around and connected to the rotor disk. The second set of compressor blades may be arranged around and connected to the rotor disk downstream of the first set of compressor blades.

More than fifty percent of components included in the first turbine engine may be configured substantially similar to corresponding components in the second turbine engine.

The foregoing features and the operation of the invention will become more apparent in light of the following description and the accompanying drawings.

### BRIEF DESCRIPTION OF THE DRAWINGS

FIG. 1 is a partial sectional illustration of an example geared turbofan turbine engine.

FIG. 2 is a partial schematic illustration of the turbine engine of FIG. 1.

FIG. 3 is a partial schematic illustration of an example of a low pressure compressor section.

FIG. 4 is a partial schematic illustration of another example geared turbofan turbine engine.

FIG. 5 is a partial schematic illustration of another example geared turbofan turbine engine.

FIG. 6 is a partial schematic illustration of another example geared turbofan turbine engine providing forward thrust.

FIG. 7 is a partial schematic illustration of the turbine engine of FIG. 6 providing reverse thrust.

FIG. 8 is a partial schematic illustration of another example geared turbofan turbine engine providing forward thrust.

FIG. 9 is a partial schematic illustration of the turbine engine of FIG. 8 providing reverse thrust.

FIG. 10 is a flow diagram of a method for manufacturing a plurality of turbine engines.

### DETAILED DESCRIPTION OF THE INVENTION

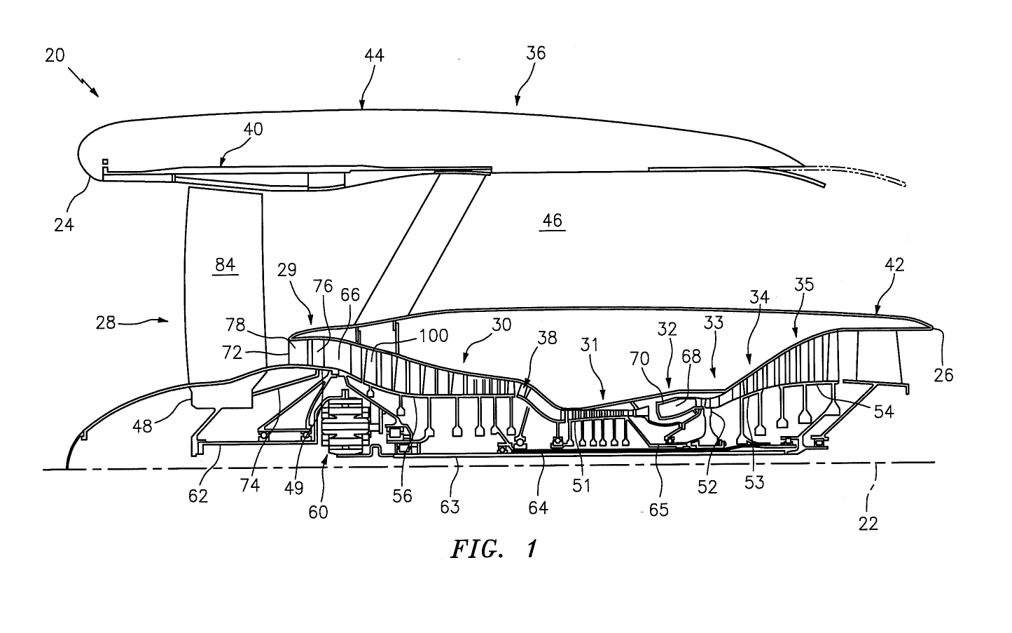

FIG. 1 is a partial sectional illustration of a geared turbofan turbine engine 20. The turbine engine 20 extends along an axial centerline 22 between an upstream airflow inlet 24 and a downstream airflow exhaust 26. The turbine engine 20 includes a fan section 28, a compressor section, a combustor section 32 and a turbine section. The compressor section includes a low pressure compressor (LPC) section 29, an intermediate pressure compressor (IPC) section 30 and a high pressure compressor (HPC) section 31. The turbine section includes a high pressure turbine (HPT) section 33, an intermediate pressure turbine (IPT) section 34 and a low pressure turbine (LPT) section 35.

The engine sections 28-35 are arranged sequentially along the centerline 22 within an engine housing 36. This housing 36 includes an inner (e.g., core) casing 38 and an outer (e.g., fan) casing 40. The inner casing 38 houses the LPC section 29 and the engine sections 30-35, which form a multi-spool core of the turbine engine 20. The outer casing 40 houses at least the fan section 28. The engine housing 36 also includes an inner (e.g., core) nacelle 42 and an outer (e.g., fan) nacelle 44. The inner nacelle 42 houses and provides an aerodynamic cover for the inner casing 38. The outer nacelle 44 houses and provides an aerodynamic cover the outer casing 40. The outer nacelle 44 also overlaps a portion of the inner nacelle 42 thereby defining a bypass gas path 46 radially between the nacelles 42 and 44. The bypass gas path 46, of course, may also be partially defined by the outer casing 40 and/or other components of the turbine engine 20.

Each of the engine sections 28-31 and 33-35 includes a respective rotor 48-54. Each of these rotors 48-54 includes a plurality of rotor blades (e.g., fan blades, compressor blades or turbine blades) arranged circumferentially around and connected to one or more respective rotor disks. The rotor blades, for example, may be formed integral with or mechanically fastened, welded, brazed, adhered and/or otherwise attached to the respective rotor disk(s).

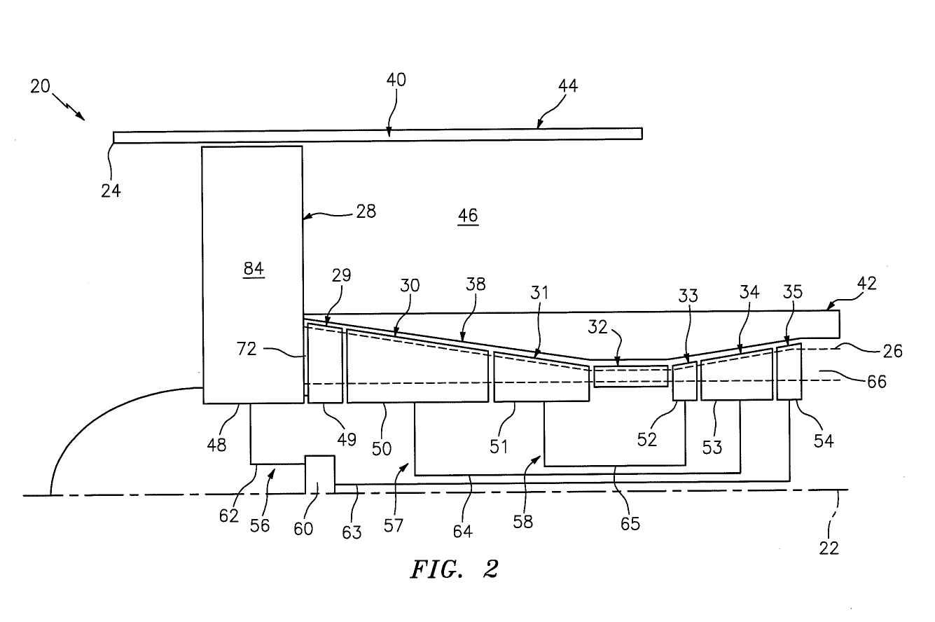

Referring to FIG. 2, the rotors 48-54 are respectively configured into a plurality of rotating assemblies 56-58. The first rotating assembly 56 includes the fan rotor 48, the LPC rotor 49 and the LPT rotor 54. The first rotating assembly 56 also includes a gear train 60 and one or more shafts 62 and 63, which gear train 60 may be configured as an epicyclic gear train with a planetary or star gear system. The LPC rotor 49 is connected to the fan rotor 48. The fan rotor 48 is connected to the gear train 60 through the fan shaft 62. The LPC rotor 49 is therefore connected to the gear train 60 through the fan rotor 48 and the fan shaft 62. The gear train 60 is connected to and driven by the LPT rotor 54 through the low speed shaft 63.

The second rotating assembly 57 includes the IPC rotor 50 and the IPT rotor 53. The second rotating assembly 57 also includes an intermediate speed shaft 64. The IPC rotor 50 is connected to and driven by the IPT rotor 53 through the intermediate speed shaft 64.

The third rotating assembly 58 includes the HPC rotor 51 and the HPT rotor 52. The third rotating assembly 58 also includes a high speed shaft 65. The HPC rotor 51 is connected to and driven by the HPT rotor 52 through the high speed shaft 65.

Referring to FIG. 1, one or more of the shafts 62-65 may be coaxial about the centerline 22. One or more of the shafts 63-65 may also be concentrically arranged. The low speed shaft 63 is disposed radially within and extends axially through the intermediate speed shaft 64. The intermediate speed shaft 64 is disposed radially within and extends axially through the high speed shaft 65. The shafts 62-65 are rotatably supported by a plurality of bearings; e.g., rolling element and/or thrust bearings. Each of these bearings is connected to the engine housing 36 (e.g., the inner casing 38) by at least one stationary structure such as, for example, an annular support strut.

During operation, air enters the turbine engine 20 through the airflow inlet 24. This air is directed through the fan section 28 and into a core gas path 66 and the bypass gas path 46. The core gas path 66 flows sequentially through the engine sections 29-35. The air within the core gas path 66 may be referred to as “core air”. The air within the bypass gas path 46 may be referred to as “bypass air”.

The core air is compressed by the compressor rotors 49-51 and directed into a combustion chamber 68 of a combustor 70 in the combustor section 32. Fuel is injected into the combustion chamber 68 and mixed with the compressed core air to provide a fuel-air mixture. This fuel air mixture is ignited and combustion products thereof flow through and sequentially cause the turbine rotors 52-54 to rotate. The rotation of the turbine rotors 52-54 respectively drive rotation of the compressor rotors 51-49 and, thus, compression of the air received from a core airflow inlet 72. The rotation of the turbine rotor 54 also drives rotation of the fan rotor 48, which propels bypass air through and out of the bypass gas path 46. The propulsion of the bypass air may account for a majority of thrust generated by the turbine engine 20, e.g., more than seventy-five percent (75%) of engine thrust. The turbine engine 20 of the present disclosure, however, is not limited to the foregoing exemplary thrust ratio.

The exemplary LPC rotor 49 of FIG. 1 includes a rotor disk 74 and one set of compressor blades 76. These compressor blades 76 are arranged around and connected to the rotor disk 74 as described above. The compressor blades 76 are adjacent to and downstream of a set of stator vanes 78. These stator vanes 78 may be positioned generally at the inlet 72 to the core gas path 66. In other embodiments, however, the stator vanes 78 may be positioned downstream of the compressor blades 76. In still other embodiments, an additional set of stator vanes may be positioned downstream and adjacent the compressor blades 76.

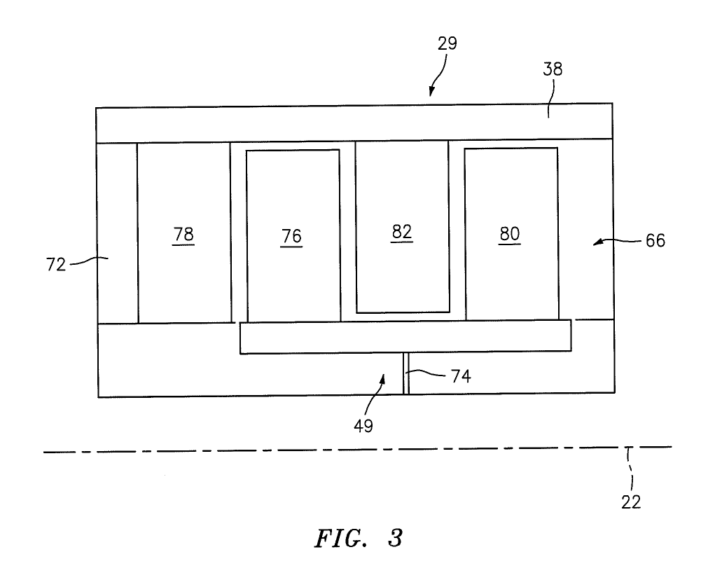

While the LPC rotor 49 is described above as including a single set of compressor blades 76, the turbine engine 20 of the present disclosure is not limited to such a configuration. For example, referring to FIG. 3, the LPC rotor 49 may alternatively include two sets of compressor blades 76 and 80 disposed at different axial locations along the rotor disk 74. The first set of compressor blades 76, for example, is positioned adjacent and downstream of the stator vanes 78. The second set of compressor blades 80 is positioned downstream of the first set of compressor blades 76. The two sets of compressors blades 76 and 80 may be separated by another set of stator vanes 82 so as to provide the LPC section 29 with two stages. Of course, in other embodiments, the LPC rotor 49 may include more than two sets of compressor blades and provide the LPC section 29 with more than two stages.

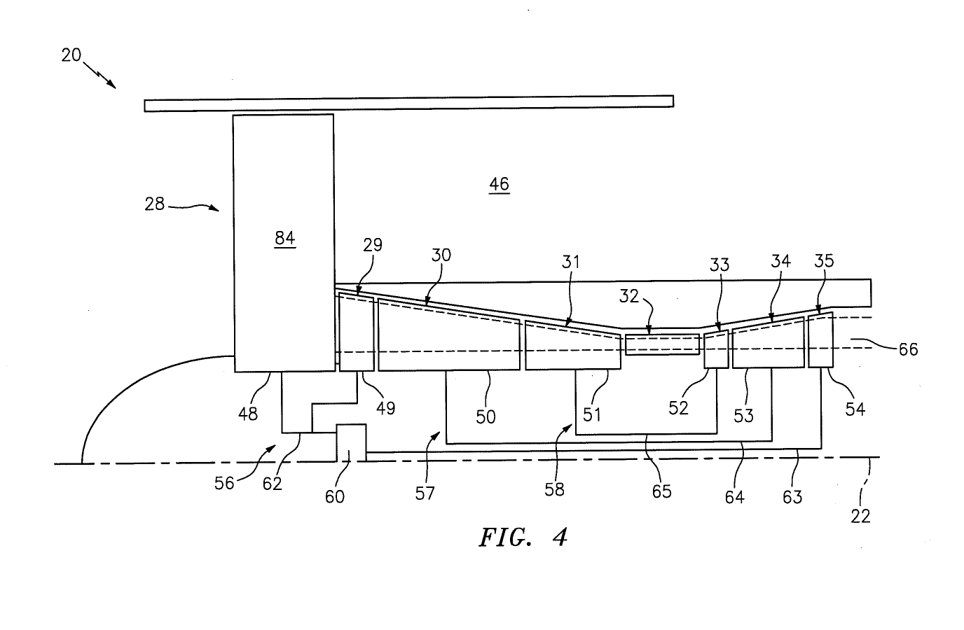

Referring to FIG. 4, in some embodiments, the LPC rotor 49 may be connected to the fan shaft 62 and the gear train 60 independent of the fan rotor 48. The LPC rotor 49 and the fan rotor 48, for example, may be connected to the fan shaft 62 and, thus, the gear train 60 in parallel.

Referring to FIG. 5, in some embodiments, the LPC rotor 49 may be connected directly to the low speed shaft 63 and, thus, independent of the gear train 60. With this configuration, the LPC rotor 49 and the LPT rotor 54 rotate at the same rotational velocity. In contrast, the LPC rotor 49 of FIGS. 1, 2 and 4 rotates at a slower rotational velocity than the LPT rotor 54 due to reduction gearing of the gear train 60.

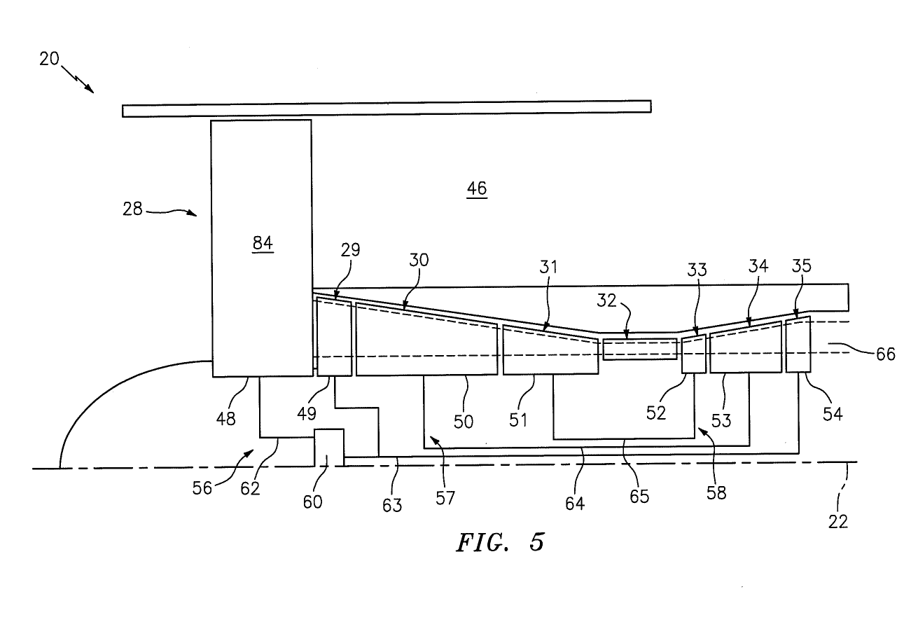

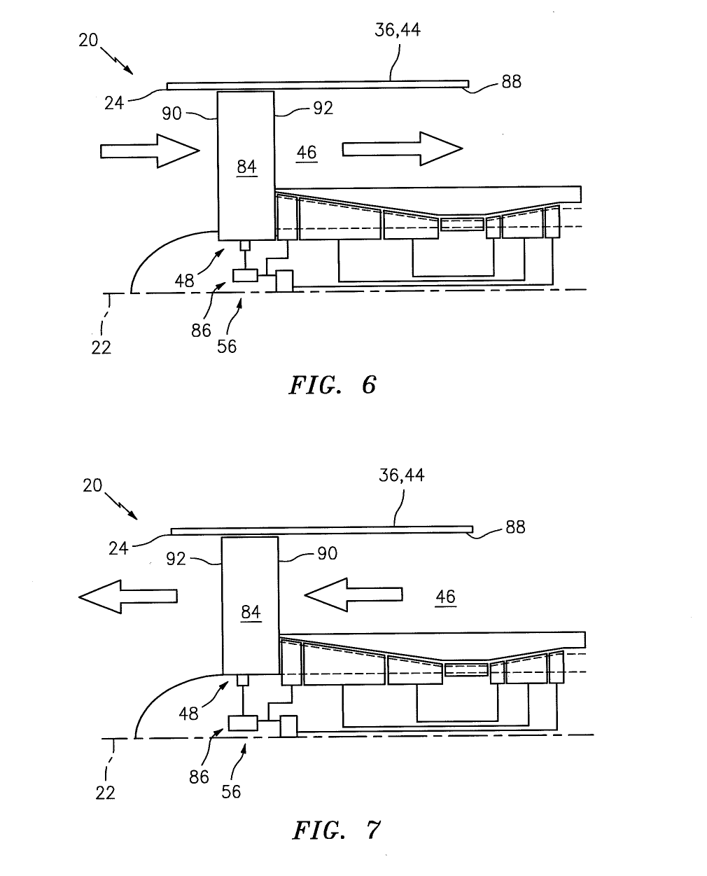

In some embodiments, the fan blades 84 may be configured as fixed blades and fixedly connected to the fan rotor 48 as illustrated in FIG. 5. In other embodiments, referring to FIG. 6, one or more of the fan blades 84 may be configured as variable pitch fan blades and pivotally connected to a hub of the fan rotor 48. With this configuration, a pitch of each respective fan blade 84 may be changed using an actuation system 86 within the hub of the fan rotor 48. This actuation system 86 may be configured for limited variable pitch. Alternatively, the actuation system 86 may be configured for full variable pitch where, for example, fan blade pitch may be partially or completely reversed.

By reversing fan blade pitch, the fan blades 84 may be moved between a first (e.g., forward thrust) position as shown in FIG. 6 and a second (e.g., reverse thrust) position as shown in FIG. 7. In the first position of FIG. 6, the fan blades 84 and the fan rotor 48 may be operable to provide forward thrust; e.g., push air through an exhaust 88 of the bypass gas path 46 as described above. Leading edges 90 of the fan blades 84, for example, may be axially forward of trailing edges 92 of the fan blades 84. In the second position of FIG. 7, the fan blades 84 and the fan rotor 48 may be operable to provide reverse thrust; e.g., push air through the airflow inlet 24. The leading edges 90 of the fan blades 84, for example, may be axially aft of the trailing edges 92 of the fan blades 84. With such a configuration, the turbine engine 20 may be configured without a traditional thrust reverser in the outer nacelle 44.

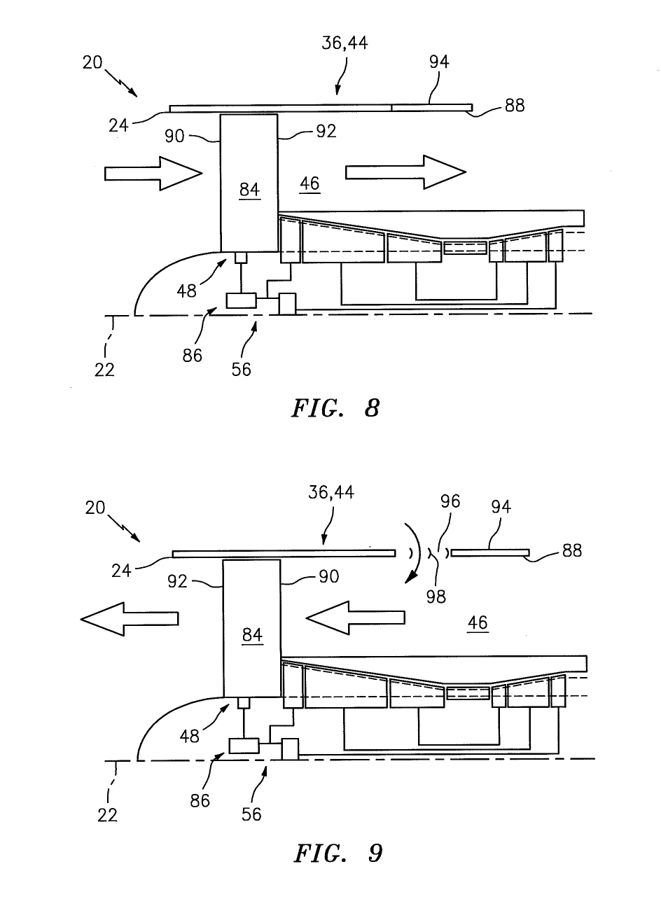

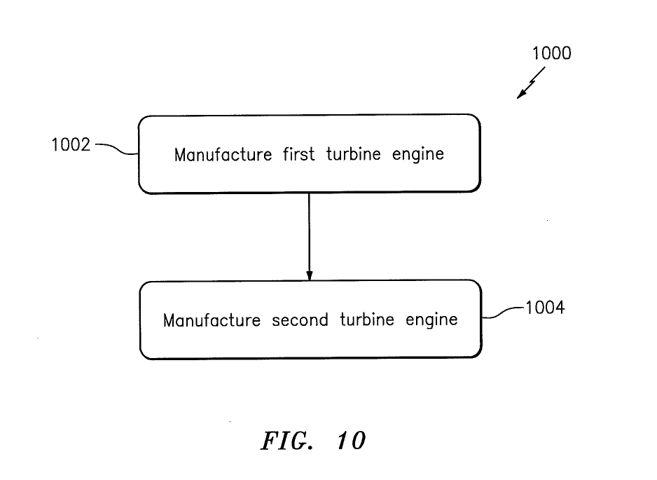

When providing reverse thrust, air may flow into the bypass gas path 46 through the exhaust 88 as shown in FIG. 7. Alternatively, the outer nacelle 44 may include an aft translating sleeve 94 as shown in FIGS. 8 and 9. When the fan blades 84 are in the second position (see FIG. 9) for providing reverse thrust, the sleeve 94 may be translated aft so as to open a passageway 96 through the outer nacelle 44. This passageway 96 may include one or more turning scoops 98 so as to assist in redirecting air into the bypass gas path 46. These turning scoops 98 may be in the form of stationary turning vanes and/or radially deployable turning vanes. However, when the fan blades 84 are in the first position (see FIG. 8) for providing forward thrust, the sleeve 94 may be translated forwards so as to close the passageway 96 and stow the turning scoops 98.

As the fan blades 84 move from the first position to the second position, the leading edges 90 may turn in a forward direction. Here the forward direction is “forward” relative to rotation of the fan rotor 48. For example, if the fan rotor 48 is turning in a clockwise direction, the leading edge 90 of each respective fan blade 84 may start moving in a clockwise direction before it reverses pitch and moves in a counter-clockwise direction. However, in other embodiments, as the fan blades 84 move from the first position to the second position, the leading edges 90 may turn in a reverse direction.

FIG. 10 is a flow diagram of a method 1000 for manufacturing a plurality of turbine engines. These turbine engines may be manufactured by a common entity; e.g., a manufacturer. The turbine engines may also or alternatively be manufactured for a common entity; e.g., a customer or end user. The turbine engines may still also or alternatively be manufactured generally contemporaneously, in common production run/cycle and/or during back-to-back production runs/cycles.

In step 1002, a first turbine engine is manufactured. In step 1004, a second turbine engine is manufactured. The first turbine engine and/or the second turbine engine may each have a configuration generally similar to the turbine engine 20 embodiments described above. However, the first turbine engine may be configured for a first thrust rating whereas the second turbine engine may be configured for a second thrust rating that is different (e.g., lower) than the first thrust rating. For example, the first thrust rating may be 10× whereas the second thrust rating may be 7×. The method 1000 of the present disclosure, however, is not limited to the foregoing exemplary thrust rating ratio.

The thrust ratings of the first and the second turbine engines may be dependent upon various parameters. These parameters may include, but are not limited to, the following:
Geometry (e.g., shape and size) of the fan blades (e.g., 84);
Number of the fan blades (e.g., 84);
Geometry of the compressor blades (e.g., 76, 80);
Number of the compressor blades (e.g., 76, 80);
Number of stages in the LPC section (e.g., 29);
Configuration of the gear train (e.g., 60); and
Configuration components in and operation of the core.

The first and the second turbine engines may each be configured for its specific thrust rating by changing one or more of the foregoing parameters. However, if the first and the second turbine engines are each configured with substantially similar cores and one or more other parameters (e.g., geometry of compressor blades and/or fan blades, number of LPC stages, gear train gearing, etc.) are changed to achieve the desired thrust ratings, then time and costs associated with engineering and/or manufacturing the first and the second turbine engines may be reduced. For example, if the first and the second turbine engines are configured with multi-spool cores having substantially similar configurations, then more than about fifty percent (50%) of the components included in the first turbine engine may be substantially similar to corresponding components in the second turbine engine. Thus, a single set of core components and/or other components may be engineered and manufactured for use in both the first and the second turbine engines. This commonality in turn may reduce research and development time and costs as well as manufacturing time and costs.

The phrase “substantially similar” is used herein to describe a set of components with generally identical configurations; e.g., sizes, geometries, number of rotor stages, etc. However, the components need not be completely identical. For example, in some embodiments, substantially similar components may be made of different materials and/or have different coatings. In some embodiments, substantially similar components may include different accessory mounts and/or locate accessories at different positions. In some embodiments, substantially similar components may include different cooling passages, different seals, different cooling features (e.g., turbulators or fins), etc.

In some embodiments, the first and the second turbine engines may include substantially similar multi-spool cores as described above. For example, the inner case of the first turbine engine and the inner case of the second turbine engine may have substantially similar configurations. The combustor 70 of the first turbine engine and the combustor 70 of the second turbine engine may also or alternatively have substantially similar configurations.

However, corresponding rotor blades in one or more of the engine sections may be slightly different. For example, an upstream-most set of compressor blades 100 (see FIG. 1) in the core of the first turbine engine may define a cross-sectional annular first area. An upstream-most set of compressor blades 100 in the core of the second turbine engine may define a cross-sectional annular second area which is slightly different than the first area. The second area, for example, may be within plus/minus twenty percent (+/−20%) of the first area.

The first and the second turbine engines are described above with certain commonalities and certain differences. These commonalities and differences, however, may change depending upon the specific thrust rating requirements, customer requirements, government agency requirements, etc. The present disclosure therefore is not limited to the exemplary embodiments described above.

The present disclosure is not limited to the exemplary turbine engine 20 configurations described above. In some embodiments, for example, the core may include more than two rotating assemblies; e.g., three spools, four spools, etc. The core, for example, may include an additional intermediate compressor rotor and an additional intermediate turbine rotor connected together by an additional intermediate speed shaft. In some embodiments, the rotating assembly may include at least one additional compressor rotor where, for example, the LPC rotor 49 and the additional compressor rotor are arranged on opposite sides of the gear train 60. Furthermore, the present disclosure is not limited to a typical turbine engine configuration with the fan section 28 forward of the core (e.g., engine sections 30-35). In other embodiments, for example, the turbine engine 20 may be configured as a geared pusher fan engine or another type of gear turbine engine. The present invention therefore is not limited to any particular types or configurations of turbine engines.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A turbine engine, comprising:
a fan rotor, a first compressor rotor, a second compressor rotor, a third compressor rotor, a first turbine rotor, a second turbine rotor, a third turbine rotor and a gear train;
wherein the fan rotor and the first compressor rotor are connected to the first turbine rotor through the gear train, wherein the second compressor rotor is connected to the second turbine rotor, and wherein the third compressor rotor is connected to the third turbine rotor.

2. The turbine engine of claim 1, further comprising:
a first shaft connecting the gear train to the first turbine rotor;
a second shaft connecting the second compressor rotor to the second turbine rotor; and
a third shaft connecting the third compressor rotor to the third turbine rotor.

3. The turbine engine of claim 2, wherein the second shaft extends through the third shaft, and the first shaft extends through the second shaft.

4. The turbine engine of claim 1, wherein the first compressor rotor is connected to the gear train through the fan rotor.

5. The turbine engine of claim 1, wherein the first compressor rotor is connected to the gear train independent of the fan rotor.

6. The turbine engine of claim 1, wherein the first compressor rotor includes a first set of compressor blades and a second set of compressor blades downstream of the first set of compressor blades.

7. The turbine engine of claim 1, wherein the fan rotor includes one or more variable pitch fan blades.

8. The turbine engine of claim 7, wherein the variable pitch fan blades are configured to move between a first position and a second position, the fan rotor is operable to provide forward thrust where the variable pitch fan blades are in the first position, and the fan rotor is operable to provide reverse thrust where the variable pitch fan blades are in the second position.

9. The turbine engine of claim 8, further comprising a nacelle housing the fan rotor, wherein the nacelle includes a translating sleeve configured to open a passageway through the nacelle where the variable pitch fan blades are in the second position, and wherein the translating sleeve is configured to close the passageway where the variable pitch fan blades are in the first position.

10. The turbine engine of claim 8, wherein a leading edge of a first of the variable pitch fan blades moves in a forward direction as that blade moves from the first position to the second position.

11. A turbine engine, comprising:
a first rotating assembly including a fan rotor, a first compressor rotor, a first turbine rotor and a gear train;
a second rotating assembly including a second compressor rotor and a second turbine rotor; and
a third rotating assembly including a third compressor rotor and a third turbine rotor.

12. The turbine engine of claim 11, wherein the gear train connects the fan rotor and the first compressor rotor to the first turbine rotor.

13. The turbine engine of claim 12, wherein the first compressor rotor is connected to the gear train through the fan rotor.

14. The turbine engine of claim 12, wherein the fan rotor and the first compressor rotor are connected to the gear train in parallel.

15. The turbine engine of claim 11, further comprising a shaft, wherein the gear train connects the fan rotor to the shaft, and the shaft connects the gear train and the first compressor rotor to the first turbine rotor.

16. The turbine engine of claim 11, wherein the first compressor rotor consists essentially of a rotor disk and a set of compressor blades arranged around and connected to the rotor disk.

17. The turbine engine of claim 11, wherein the first compressor rotor includes
a rotor disk;
a first set of compressor blades arranged around and connected to the rotor disk; and
a second set of compressor blades arranged around and connected to the rotor disk downstream of the first set of compressor blades.

18. The turbine engine of claim 11, wherein the fan rotor includes one or more variable pitch fan blades.

19. A method for manufacturing, comprising:
manufacturing a first turbine engine configured for a first thrust rating, wherein the first turbine engine includes a rotating assembly and a first multi-spool core, and wherein the rotating assembly includes a fan rotor, a compressor rotor, a turbine rotor and a gear train; and
manufacturing a second turbine engine configured for a second thrust rating which is different than the first thrust rating, wherein the second turbine engine includes a second multi-spool core;
wherein an upstream-most set of compressor blades of the first multi-spool core defines a first area, and an upstream-most set of compressor blades of the second multi-spool core defines a second area that is within plus/minus twenty percent of the first area; and
wherein the first and the second turbine engines are manufactured by and/or for a common entity.

20. The method of claim 19, wherein more than fifty percent of components included in the first turbine engine are configured substantially similar to corresponding components in the second turbine engine.
